(19) United States
(12) Patent Application Publication
(10) Pub. No.: US 2025/0178261 A1
(43) Pub. Date: Jun. 5, 2025

(54) METHOD AND DEVICE FOR PRODUCING A CUSHION MATERIAL AND CUSHION MATERIAL

(71) Applicants: Faurecia Autositze GmbH, Hannover (DE); INDORAMA VENTURES MOBILITY OBERNBURG GmbH, Obernburg (DE)

(72) Inventors: Mathieu Cluet, Etampes (FR); BenoÎt Gazaniol, Arpajon (FR); David Boudot, Magny-Vernois (FR); Michael Neidhöfer, Mainz (DE); Frank Leymann, Elsenfeld (DE)

(21) Appl. No.: 18/958,642

(22) Filed: Nov. 25, 2024

(30) Foreign Application Priority Data
Nov. 30, 2023 (DE) 10 2023 212 045.3

(51) Int. Cl. B29C 48/05; B29C 48/00; B29K 67/00; B29L 31/00; B60N 2/64; B60N 2/90

(52) U.S. Cl. CPC B29C 48/05; B29C 48/0021; B60N 2/90; B29K 2067/00; B29L 2031/771; B60N 2/64

(57) ABSTRACT

A Method for producing a cushion material for manufacture of seat cushions may extrude a material comprising at least one thermoplastic polymer in an extrusion device, thereby producing a curtain of molten endless fibers, that falls due to gravity. The extrusion device comprising multiple extrusion nozzles that are distributed in a longitudinal direction and in a lateral direction of the extrusion device, and a pressure adjustment arrangement to adjust an extrusion pressure. The Method may receive the curtain of molten endless fibers between two counter-rotating rollers, thereby producing a 3D tangle of irregularly distributed endless fibers which form loops that are fused together. The Method may solidify the 3D tangle by immersion in a cooling liquid.

### CLAIM FOR PRIORITY

This application claims the benefit of priority of German Application No. 10 2023 212 045.3, filed Nov. 30, 2023, which is hereby incorporated by reference in its entirety.

### TECHNICAL FIELD

The present disclosure relates to a method and a device for producing a cushion material and a cushion material. In particular, the cushion material can be configured for the manufacture of seat cushions and can be intended, for example, for vehicle seats, especially for those of motor vehicles and/or airplanes and/or trains.

### BACKGROUND

Vehicle seats can include a frame, multiple cushion elements, and a cover material. In particular, the cushion elements serve to provide support and comfort to a vehicle occupant. The cushions can consist of a foam material, e.g., of an injection-molded polyethylene, or of a urethane polymer foam molded in special molds.

### SUMMARY/OVERVIEW

Especially to give vehicle seats locally varying support or comfort properties, it can be of interest to arrange cushion elements with different hardness in a vehicle seat, which can require the separate production and installation of cushion elements with appropriate individual hardness.

The present disclosure is based on the task of reducing the production expense of vehicle seats. Accordingly, a method is proposed for producing a cushion material for the manufacture of seat cushions, this method can include the following measures:
a) Extruding a material comprising at least one thermoplastic polymer in an extrusion device to form a curtain of molten endless fibres falling due to gravity, wherein the extrusion device comprises multiple extrusion nozzles that are distributed in a longitudinal direction and in a lateral direction of the extrusion device, and a pressure adjusting arrangement to adjust an extrusion pressure;
b) Receiving, between two counter-rotating rollers, the curtain that is made of molten endless fibers and that falls due to gravity, thereby producing a three-dimensional 3D tangle of irregularly distributed endless fibers which are looped together and fused together,
c) Solidifying the 3D tangle by immersion in a cooling liquid, the method may further comprise at least of at least one of the following measures during ongoing and/or continuous extrusion or, in other words, during the extrusion:
d) temporal and/or local variation of the extrusion pressure;
e) varying a conveyance speed at which the curtain is conveyed through the rollers.

The endless fibers can be hollow fibers and/or solid fibers. They can have, for example, a diameter between 0.2 mm and 2 mm, preferably between 0.3 mm and 1.5 mm. A composition of the endless fibers can comprise, for example, at least 95 weight % polyester. In general, a composition of the continuous fibers can comprise multiple different thermoplastic polymers, however preferably exclusively thermoplastic polymers.

The 3D tangle that is produced can, for example, have a density between 20 kg/m³ and 70 kg/m³. Especially to improve an air circulation and/or moisture absorption, the 3-D tangle can have gaps between the endless fibers and especially between their fused or, in other words, welded loops that remain at least partly or completely free.

In the term “endless fiber”, “endless” can mean that the fibers have a length that is much greater than the diameter of the fibers, for example by a ratio of at least 100 or even 1,000 or even 5,000.

A loop or an entanglement can, in particular, comprise or be formed by a continuous fiber crossing itself or being fused with an adjacent endless fiber.

The rollers can be comprised by or form a calender arrangement and/or can be calender organs.

The rollers can each rotate around axes of rotation that run parallel to one another. Additionally or alternatively, these axes of rotation can run parallel to the longitudinal direction of the extrusion device. A falling direction or, in other words, a direction in which the curtain extends in the direction of the rollers can run orthogonal to the longitudinal direction and/or the lateral direction the extrusion device. The lateral direction and the longitudinal direction of the extrusion device can run orthogonal to one another.

Here, terms such as direction, axis, extension, and dimension can be used interchangeably, especially with regard to a common spatial orientation.

The 3D tangle and, in particular, a cushion material formed by it, can be produced as an elongated web, here also referred to as a cushion material web or a material web. This can result, in particular from a continuous performance of the method disclosed here as is generally possible in accordance with embodiments.

A longitudinal dimension of the 3D tangle and/or of the material web can correspond to a guidance direction or, in other words, to a conveyance direction of the extruded material through the counter-rotating rollers.

A thickness dimension of the 3D tangle and/or of the material web can be determined by a separation of the axes of rotation of the counter-rotating rollers. The lateral direction of the extrusion device can correspond to the thickness dimension of the 3D tangle and/or of the material web, and/or cause a material extrusion in the direction of or along this thickness dimension.

A lateral dimension of the 3D tangle and/or of the cushion material can be determined by a longitudinal dimension of the extrusion device and especially by its extrusion nozzle distribution in the longitudinal direction. In general, the lateral direction of the extrusion device can correspond to the thickness dimension of the 3D tangle and/or of the material web, and/or cause a material extrusion in the direction of or along this thickness dimension.

The extrusion nozzles can especially be evenly distributed in the longitudinal direction and/or in the lateral direction of the extrusion device. The optional temporal and/or local variation of the extrusion pressure can be done by corresponding control of the extrusion device and especially its pressure adjustment arrangement.

The conveyance speed of the curtain through the rollers can, even in the case of an optional variation thereof, lie below a falling speed of the endless fiber curtain, in order to cause an increased loop formation.

The conveyance speed can generally be adjusted by changing a rotational speed of at least one of the rollers. Alternatively or additionally, other rollers and/or calender arrangements can be provided that receive and convey the solidified 3D tangle, and their rotational speeds can affect the conveyance speed through the rollers picking up the curtain. To vary this conveyance speed, the rotational speeds of these optional other rollers can be varied.

The solidification of the 3D tangle preferably occurs very shortly in time after (for example within less than 5 seconds), and especially immediately after the formation of the 3D tangle. For this purpose in particular, the rollers receiving the curtain can be at least partly immersed in the cooling liquid, for example up to half their diameter.

An extrusion temperature, with which the extrusion device extrudes the material, can lie, for example, between 180° C. and 260° C. The material to be extruded can be fed to the extrusion device especially in the form of a polymer granulate to be melted.

Varying the extrusion pressure can vary the throughput of the extruded material through the extrusion device, especially locally and/or temporally. This can correspondingly vary the density of the 3D tangle and/or cushion material that is produced. The varying density is accompanied by correspondingly varying hardness properties.

In particular, an at least temporal and/or local increase in the expansion pressure can temporally and/or locally increase the density. By contrast, a decrease in the expansion pressure can correspondingly decrease the density. Increasing the extrusion pressure can comprise an increase of at least 10%, at least 20%, or at least 50% in comparison with a lowest extrusion pressure in the method and/or an immediately preceding extrusion pressure. Decreasing the extrusion pressure can comprise a decrease of at least 10%, at least 20%, or at least 50% in comparison with a highest extrusion pressure in the method and/or an immediately preceding extrusion pressure.

Similarly, the conveyance speed of the curtain through the rollers can affect the density of the 3D tangle that is produced and/or of the cushion material. In particular, a decrease in the conveyance speed can increase the density, since the extruded material is metaphorically speaking transported away and/or transported away less quickly. By contrast, an increase in the conveyance speed can correspondingly decrease the density.

Thus, the method presented here can directly form, in the 3D tangle and/or cushion material, especially when it is continuously produced, regions with varying density and thus varying hardness. Subsequently, parts can be separated out from the 3D tangle and/or cushion material for use and/or further processing as seat cushions. These parts can have both regions with a correspondingly increased density and also regions whose density is correspondingly decreased in comparison. Separating out such parts, for example by cutting, can be a separate measure of the method disclosed here. The parts can be brought into a desired final installation shape by further processing.

According to one embodiment, the variation in the conveyance speed and possibly the temporal variation of the extrusion pressure are periodic. This variation can generally comprise increasing and decreasing the conveyance speed and/or the extrusion pressure, especially doing so in alternation and/or at least temporarily. The variation in the conveyance speed or extrusion pressure can represent a deviation of at least 10%, at least 20%, or at least 50% in comparison with the method's maximum and/or minimum and/or immediately preceding values.

Periodic variation can produce regions with increased and/or decreased density at correspondingly even intervals, especially in the longitudinal direction of the 3D tangle and/or cushion material that is produced. This simplifies a subsequent separating out of individual parts as seat cushions or for the manufacture of seat cushions. This can also reduce waste material.

The regions with correspondingly increased and/or decreased density produced by varying the conveyance speed can extend over the entire width of the 3D tangle and/or cushion material that is produced. Within each of these regions the density can be essentially homogeneous.

According to one embodiment, the local variation of the extrusion pressure comprises producing an uneven distribution of the extrusion pressure along the longitudinal direction of the extrusion device. In other words, the extrusion pressure in this longitudinal direction is not homogeneous and is not constant. The uneven distribution of the extrusion pressure along the longitudinal direction of the extrusion device can be equivalent to producing a correspondingly uneven material throughput through the extrusion nozzles in the longitudinal direction. In particular, a middle region along the longitudinal direction of the extrusion device (or the lateral direction of the 3D tangle and/or of the cushion material that is produced) can have a pressure that is different, in particular lower, than that of at least one outer region viewed in the longitudinal direction of the extrusion device. For example, the distribution of the extrusion pressure in the longitudinal direction can be symmetric about the middle region of the extrusion device.

A corresponding distribution of the extrusion pressure can achieve a corresponding distribution of density in the curtain of endless fibers and/or the 3D tangle along the longitudinal direction of the extrusion device (or in the lateral direction of the 3D tangle).

In particular, the uneven distribution of the extrusion pressure can be maintained continuously. In this way, an elongated material web can be produced that has, when viewed in its longitudinal direction, elongated and in particular continuous regions with a density that deviates from that of adjacent regions.

According to one embodiment, the method has at least the measure e) and the extrusion pressure is kept constant or temporally varied to a lesser extent than the conveyance speed. The extent of the variation can, for example, relate to a relative difference from a respective value of the extrusion pressure or the conveyance speed before a currently viewed time point, or can be defined as such. The fact that the conveyance speed is (relatively) varied to a greater extent than the extrusion pressure means that the targeted influence on the density targeted by varying the conveyance speed may not affected, or only slightly.

According to one embodiment, the method has at least the measure d) concerning the temporal variation in the extrusion pressure, while the conveyance speed is kept constant or temporally varied to a lesser extent. The respective extent of the variation can be defined as previously described. Analogous advantages result that describe how to vary the conveyance speed while the extrusion pressure is less strongly varied.

According to one embodiment, the method comprises both measures d) and e), and these are performed simultaneously, at least temporarily. As described above, measure d) can produce, in particular, a density variation in a lateral direction of the 3D tangle or cushion material, while the measure e) can allow, in particular, a density variation in a lateral direction of the 3D tangle or cushion material.

If the measures d) and e) are performed in succession, which according to embodiments can also be provided alternatively or additionally, makes it possible to produce spatially separate regions with correspondingly arranged density variation in the width and in the longitudinal directions of the 3D tangle or cushion material. If the measures are performed simultaneously, the density variations in the lateral and longitudinal directions of the 3D tangle or cushion material can be overlapped, at least in sections. This makes it possible to produce, in regions, even a bent shape, or, metaphorically speaking, a region that “turns a corner” when viewed from above and/or an L-, C- or U-shaped region, for example, with a density that deviates from that of adjacent regions. This increases the degrees of freedom to produce regions of different hardness in the 3d tangle or cushion material.

Here pressure adjustment can be understood to mean especially adjusting pressure by producing a corresponding pressure, for example by applying such a pressure to a material volume. In the same way, it can be understood to mean, for example a, e.g., local pressure adjustment by distributing and/or supplying material to which a corresponding pressure has already been applied in another place.

According to another embodiment, the pressure adjustment arrangement comprises multiple extrusion pumps, in particular for direct application of pressure to material volumes, or other pressure adjustment devices, especially comprising valves whose pressure application is individually adjustable. The extrusion pumps and/or pressure adjustment devices can be distributed, especially in the longitudinal direction of the extrusion device. They can deliver correspondingly produced and/or adjusted pressure to at least parts of the extrusion nozzles. A correspondingly formed pressure adjustment arrangement can precisely adjust the pressure variation provided according to embodiments.

The present disclosure also relates to a cushion material. This cushion material can have any material properties explained here, especially those of the endless fibers and/or of the 3D tangle. Furthermore, the cushion material can be produced by a method and/or with a device in accordance with any variants described here and can have all features resulting from this.

In particular, the cushion material can have: an elongated material web comprising a 3D tangle of randomly distributed endless fibers that form loops which are fused with one another (i.e., with the loops of other endless fibers), the material web having an uneven density in a longitudinal direction. By contrast, the density can be constant in the width direction. However, it can be dependent on a position in the longitudinal direction. In particular, regions with increased and decreased density can follow one another in the longitudinal direction, for example in alternation.

Furthermore, especially the uneven density in the longitudinal direction can periodically vary, for example if the respective successive regions with increased and decreased density in the longitudinal direction are homogeneously dimensioned.

According to one embodiment, there are multiple first regions with increased density in the longitudinal direction, which are each separated from one another by a second region whose density is reduced in comparison,
the first regions each having a longitudinal extension of at least 1 cm, and/or
a longitudinal extension of the first regions is smaller than a respective separation between adjacent first regions in the longitudinal direction.

Additionally or alternatively, the longitudinal extensions of the first regions or generally of regions with increased density can be smaller than a respective lateral extension of these region. This emphasizes the inventive possibility of only locally limited increasing the density and thus hardness of the cushion material.

The present disclosure also relates to a device for producing a cushion material for manufacturing seat cushions, such as with the device comprising the following:
an extrusion device with multiple extrusion nozzles, which are distributed in a longitudinal direction and in a lateral direction of the extrusion device, and with a pressure adjustment arrangement to adjust an extrusion pressure;
at least two counter-rotating rollers,
a cooling liquid reservoir,
   the extrusion device being designed to extrude a material comprising at least one thermoplastic polymer, thereby producing a curtain of molten endless fibers that falls due to gravity,
   and the rollers being designed to receive between them the curtain of molten endless fibers that falls due to gravity to produce a 3D tangle of randomly distributed endless fibers, which form loops that are fused with one another—i.e., in particular that are fused with another loop of another endless fiber, the rollers feeding the 3D tangle that is produced to the cooling liquid reservoir for solidification.

The device is configured to implement at least one of the following measures during the extrusion:
a) temporal and/or local variation of the extrusion pressure;
b) a variation of conveyance speeds of the curtain through the rollers or, in other words, a variation of conveyance speeds at which the curtain is conveyed through the rollers.

In general, the device can be configured to perform a method according to any of the variants described here, in particular to produce a cushion material according to any of the variants described here.

Sample embodiments of the present disclosure are explained below using the whose attached figures. Across all the figures, the same reference numbers can be used for comparable features. Not all instances of a feature depicted in the figures can always be provided with a corresponding dedicated reference number of this feature.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a device according to one embodiment of the present disclosure, which performs a method according to one embodiment of the present disclosure for producing a cushion material according to one embodiment of the present disclosure.

FIG. 2 shows a device according to another embodiment of the present disclosure, which performs a method according to another embodiment of the present disclosure to produce a cushion material according to another embodiment of the present disclosure.

FIG. 3 shows a device according to yet another embodiment of the present disclosure, which performs a method according to yet another embodiment of the present disclosure to produce a cushion material according to yet another embodiment of the present disclosure.

### DETAILED DESCRIPTION

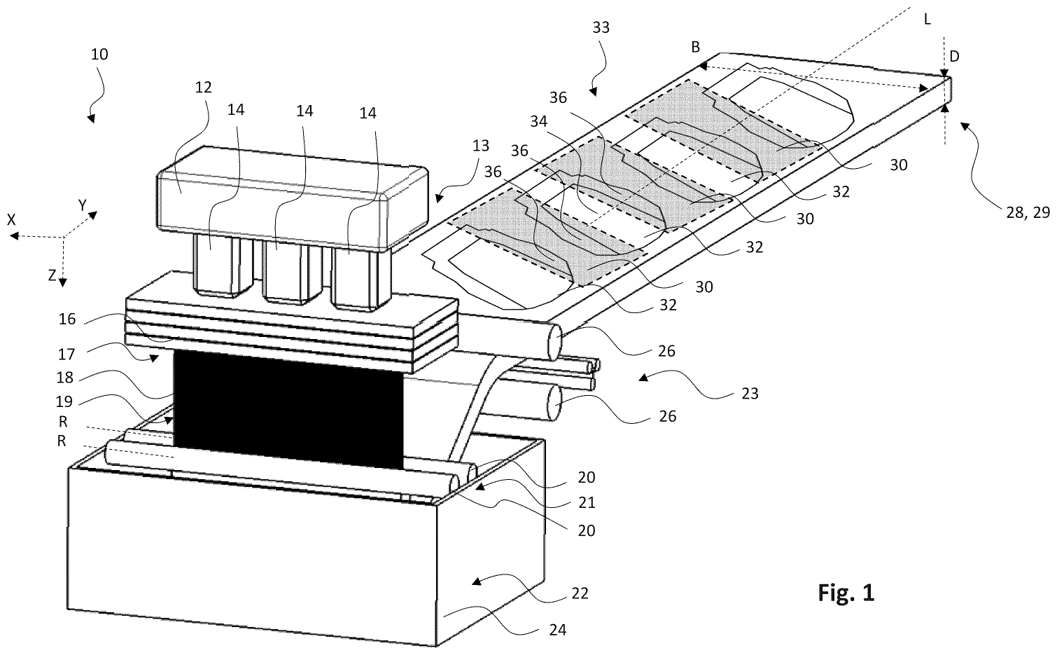

FIG. 1 shows a device 10 according to one embodiment of the present disclosure. The device 10 comprises an extrusion device 12 with a pressure adjustment arrangement 13. The pressure adjustment arrangement 13 comprises multiple pressure adjustment devices, each of which is in the form of an extrusion pump 14.

The extrusion pumps 14 are distributed along a longitudinal direction X of the extrusion device 12 and are, in particular, evenly spaced apart from one another. The longitudinal direction X runs orthogonal to a lateral direction Y of the extrusion device 12 and orthogonal to a direction Z, along which an extruded material is brought out of the extrusion device 12.

A distribution plate 16, which in principle can be designed according to the prior art, has multiple extrusion nozzles 17 that are not visible. The extrusion nozzles 17 are distributed in longitudinal direction X and lateral direction Y and form openings on the bottom of distribution plate 16.

The extrusion device 12 is supplied with a solid, in particular granular polymer material, in particular a polymer material mixture. This polymer material mixture is melted by the extrusion device 12 and the extrusion pumps 14 apply an extrusion pressure to it. To be precise, every extrusion pump 14 has a molten material volume supplied to it, which then applies an individually adjustable pressure to this pump. The material volume that has corresponding pressure applied to it is fed by each extrusion pump 14 to a group of associated extrusion nozzles 17, and is extruded by means of the latter. Preferably, the distribution plate 17 is designed in such a way, and has, in particular, regions that are separated from one another so that each extrusion nozzle 17 has material fed to it from only one of the extrusion pumps 14.

The extrusion nozzles 17 each extrude endless fibers 19 in molten form, i.e., molten endless fibers 19, with any of the properties described here. These molten continuous fibers fall due to gravity along the described Z direction and vertically downward relative to the extrusion device 12. In the process, the endless fibers 19 form a curtain 18 that is only schematically illustrated.

The curtain 18 of endless fibers 19 is received in a first calender arrangement 21 comprising two counter-rotating rollers 20, more precisely between these rollers 20. Each of the rollers 20 rotates about an axis of rotation R, which in the example shown runs parallel to the longitudinal direction X of the extrusion device 12.

Each of the rollers 20 is at least partly immersed in a cooling liquid that is held in a cooling liquid reservoir 24. In the example shown, the rollers 20 are unheated. The rollers 20 rotate, in particular with a lower speed than the falling speed of the curtain 18. More precisely, a conveyance speed of the material fed through between the rollers 20 is lower than a falling speed of the curtain 18. This results in loop formation of the endless fibers 19 themselves and possibly also among one another. In the process, the endless fibers 19 and, in particular, their loops are fused, or, in other words, welded with one another. In particular, loops of a endless fiber are welded with the loops of other endless fibers. Instead of a loop, in principle it is also possible to speak of a bow or a noose.

As a result, no later than after the curtain 18 has been passed through the rollers 20, there is a 3D tangle of irregularly (i.e., randomly) distributed endless fibers 19 that have loops, these loops being fused among one another (i.e., in particular with the loops of other endless fibers 19), at least in sections. This 3D tangle is solidified by immersion in the cooling fluid of the cooling fluid reservoir 24, resulting in a cushion material 29.

The solidified 3D tangle is brought out of the cooling fluid reservoir 24 in the form of a cushion material web 28, also referred to for brevity as material web 28. The position of a deflecting roller 22 (not shown) used for this purpose is indicated. The material web 28 is generally formed elongated along a longitudinal axis or in longitudinal direction L. It has a lateral dimension B running orthogonal to its longitudinal dimension L. A thickness dimension D defines a distance between the surfaces of the material web 28 that face away from one another, these surfaces each having, for example, the lateral dimension B.

In a subsequent step, which is not separately illustrated, individual parts 33 are separated out of this material web 28 by means of optional device components (or also with the components of a separate device) that are not separately illustrated. The parts 33 form, for example, cushions for the seat surface of a vehicle seat or can be further processed into such cushions. The seat surfaces are schematically indicated or outlined. Enclosed between them, there is a middle seat surface region 34 and seat surface regions 36.

The illustration of FIG. 1 shows that the lateral dimension B of the material web 28 that is produced corresponds to the longitudinal direction X or longitudinal dimension of the extrusion device 12. By contrast, the Z direction 12 of the extrusion device or the falling direction of the curtain 18 corresponds to the longitudinal dimension L of the material web 28.

Finally, the device 10 also comprises a second calender arrangement 23 comprising two counter-rotating rollers 26. The axes of rotation of these other rollers 26 are not separately illustrated, however they run parallel to the axes of rotation R of the rollers 20 of the first calender arrangement 21.

The presented embodiment generally provides that the conveyance speed of the curtain 18 through the rollers 20 of the first calender arrangement 21 varies over time, in particular varies periodically. In this example, this is accomplished by correspondingly temporarily increasing or decreasing the rotational speeds of the rollers 22 in the cooling liquid reservoir 24 so that the curtain 18 is guided through the first calender arrangement 21 correspondingly more quickly or more slowly.

As a consequence, the material density within the material web 28 locally varies according to the varying conveyance speed. If the conveyance speed is increased, the material density decreases in the corresponding section guided through the rollers 20, while if the conveyance speed is decreased, the material density correspondingly increases.

As a result, the material web 28 has regions 32 arranged in alternation along its longitudinal dimension L with comparatively decreased density and regions 30 with increased density. Therefore, hardness of the material web 28 correspondingly alternates along its longitudinal dimension L.

Each of the regions 30, 32 extends over the entire width B and also the entire thickness D of the material web 28. These are arranged evenly or, in other words, periodically spaced along the longitudinal direction L, which results from a correspondingly periodic variation in the conveyance speed. Accordingly, the regions 30 with increased density are each evenly dimensioned and have the same density. The regions 32 with decreased density are also each evenly dimensioned among one another and have the same density.

Furthermore, it is also shown that a region 30 with increased density always comprises components of two protruding parts 33; their lateral faces 36 are illustrated in the example. This helps reduce waste material.

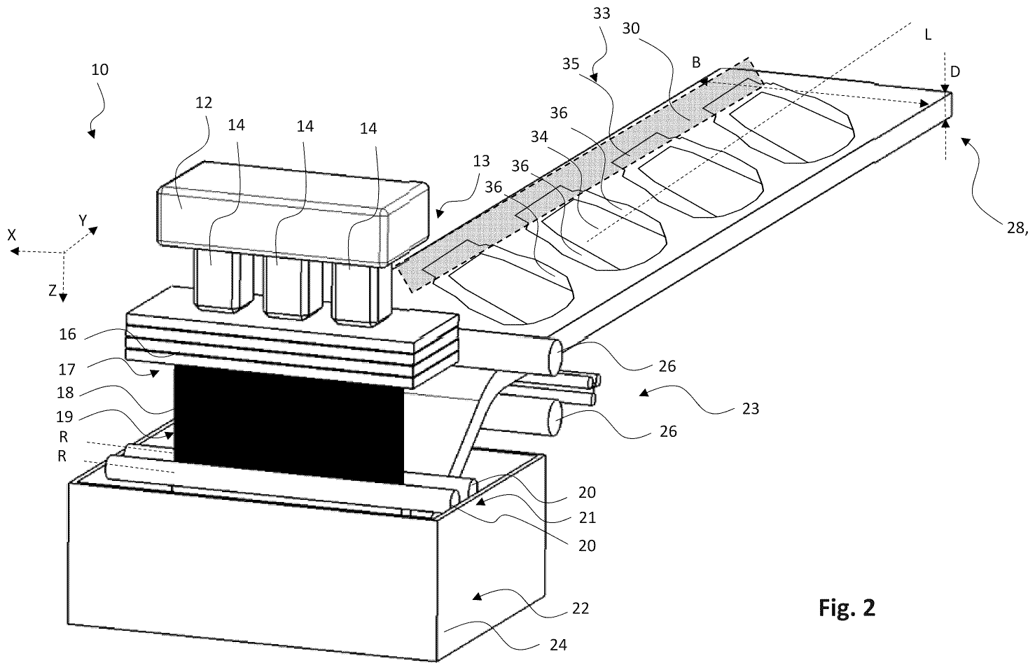

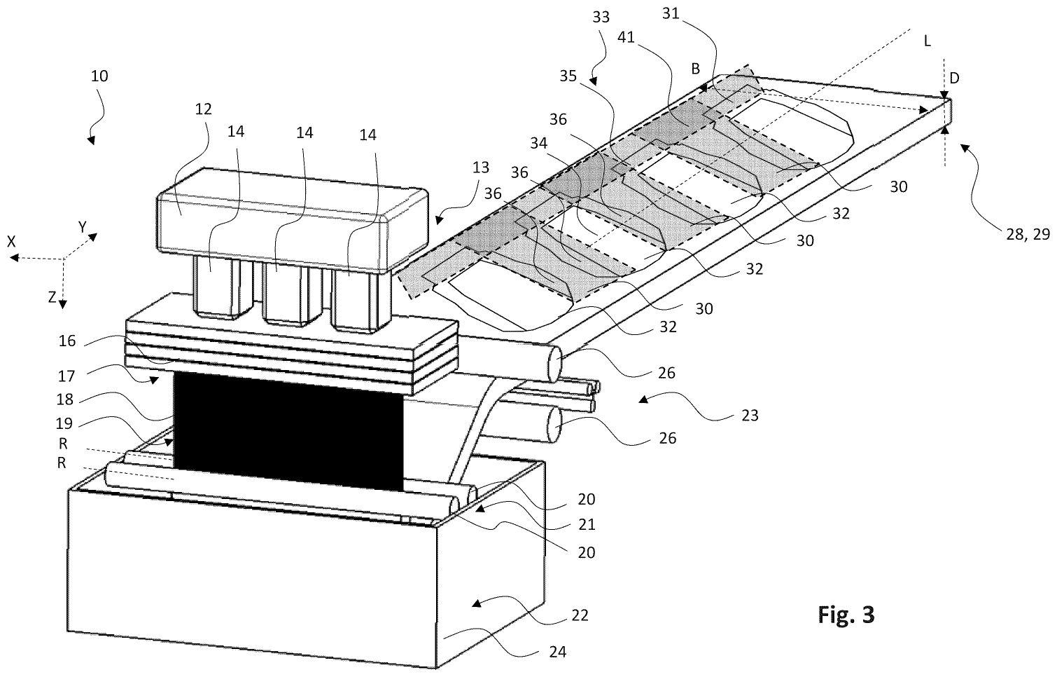

FIGS. 2 and 3 each show solutions according to other embodiments of the present disclosure. Features that are the same as in FIG. 1 are labeled with the same reference numbers, even if they are not separately explained again in every case in the context of FIGS. 2 and 3.

The embodiment of FIG. 2 differs from the variant in FIG. 1 by the spatial position and/or orientation of regions 30 with increased density within the material web 28 produced and by operating the device 10 to achieve this.

To be more precise, in this case an uneven extrusion pressure distribution is produced along the longitudinal direction X of the extrusion device 12. In the example shown, this is achieved by the fact that the extrusion pump 14 positioned farthest to the right in FIG. 2 produces a higher extrusion pressure in comparison with the other extrusion pumps 14. During continuous material production, the calender arrangements 21, 23 preferably run with a constant rotational speed.

As a result, the material throughput through the extrusion nozzles 17, which are associated with the extrusion pump 14 positioned farthest to the right, is increased, so that a region 30 of the material web 28 produced from the extrusion fibers 19 of this extrusion nozzle 17 has an increased density and thus hardness. This region 30 runs continuously in the shape of a strip along the longitudinal axis L of the material web 28.

For example, this region runs in a posterior part 35 of each of the parts 33 that are to be cut out and that form seat surfaces. However, it is understood that the seat surfaces could also be rotated by 90° with respect to the illustration in FIG. 2. Then it would be possible, for example by producing an increased extrusion pressure with the two outer extrusion pumps 14, to produce two regions 30 with increased density that run parallel to one another, each of which comprises one of the lateral faces 34 of each of the seat surfaces.

FIG. 3 shows another variant that combines the variants of FIGS. 1 and 2. Consequently, an uneven extrusion pressure distribution is produced along the longitudinal direction X of the extrusion device 12, as well as a preferably periodically varying conveyance speed of the curtain 18 through the rollers 20 of the first calender arrangement 21.

The latter, in turn, results in regions 30, 32 with increased or decreased density successively alternating along the longitudinal axis L. By contrast, the locally increased extrusion pressure produces a strip-shaped region 31 with increased density, as illustrated in in FIG. 3, this region 31 running along the longitudinal axis L.

Due to the fact that the measures mentioned for producing increased density in regions within the material web 28 are at least performed partly simultaneously, which means that each of the regions 30, 31 of increased density t are produced to overlap in an overlap region 41. If this should be prevented or at least limited, it is possible, for example, to interrupt, at least temporarily, the increase in the extrusion pressure by means of the extrusion pump 14 positioned farthest to the right in FIG. 3.

In the example shown, the material web 28 has regions 30, 31 of increased density running at an angle towards one other in such way that schematically illustrated seat surfaces can be separated out, in each of which the lateral faces 34 and the posterior part 35 running at an angle to them have an increased density. In plan view, therefore, each separated part has a C- or also (rotated) U-shaped region of increased density composed of the regions 30, 31.

What is claimed is:

1. A method for producing a cushion material for manufacture of seat cushions, the method comprising:
extruding a material comprising at least one thermoplastic polymer in an extrusion device, thereby producing a curtain of molten endless fibers that falls due to gravity, the extrusion device comprising multiple extrusion nozzles that are distributed in a longitudinal direction and in a lateral direction of the extrusion device, and a pressure adjustment arrangement to adjust an extrusion pressure;
receiving the curtain of molten endless fibers between two counter-rotating rollers, thereby producing a 3D tangle of irregularly distributed endless fibers which form loops that are fused together; and
solidifying the 3D tangle by immersion in a cooling liquid.

2. The method according to claim 1, wherein the method, during extrusion, comprises at least one of: i) at least one of temporally or locally varying the extrusion pressure, or ii) varying a conveyance speed at which the curtain is conveyed through the two counter-rotating rollers.

3. The method according to claim 2, wherein the extrusion pressure is temporally varied, wherein the conveyance speed is varied, and wherein at least one of variation of the conveyance speed or the temporal variation of the extrusion pressure are periodic.

4. The method according to claim 2, including locally varying the extrusion pressure, wherein locally varying the extrusion pressure comprises producing an uneven distribution of the extrusion pressure along the longitudinal direction of the extrusion device.

5. The method according to claim 4, wherein the uneven distribution of the extrusion pressure is continuously maintained.

6. The method according to claim 2, wherein the method includes at least varying a conveyance speed at which the curtain is conveyed through the two counter-rotating rollers and the extrusion pressure remains constant or is varied over time to a lesser extent than the conveyance speed.

7. The method according to claim 2, wherein the method includes both at least one of temporally or locally varying the extrusion pressure and varying a conveyance speed at which the curtain is conveyed through the two counter-rotating rollers, and varying the extrusion pressure and varying the conveyance speed are performed simultaneously, at least temporarily.

8. The method according to claim 1, wherein the pressure adjustment arrangement comprises multiple extrusion pumps or other pressure adjustment devices, with which an extrusion pressure is individually adjustable.

9. A cushion material comprising:
an elongated material web comprising a 3D tangle of randomly distributed endless fibers that form loops which are fused with one another, the elongated material web having an uneven density in a longitudinal direction.

10. The cushion material according to claim 9, wherein a non-uniform density in longitudinal direction periodically varies.

11. The cushion material according to claim 9, further comprising:
multiple first regions with increased density in the longitudinal direction, wherein each of the multiple first regions are separated from one another by a second area whose density is decreased in comparison, wherein at least one of i) the multiple first regions each have a longitudinal extension of at least 1 cm, or ii) a longitudinal extension of the multiple first regions are smaller than a respective separation between adjacent first regions in the longitudinal direction.

12. A device for producing a cushion material for manufacturing seat cushions, the device comprising:
an extrusion device with multiple extrusion nozzles, which are distributed in a longitudinal direction and in a lateral direction of the extrusion device, and with a pressure setting arrangement to adjust an extrusion pressure;
at least two counter-rotating rollers; and
a cooling liquid reservoir; wherein the extrusion device is configured to extrude a material comprising at least one thermoplastic polymer, thereby producing a curtain of molten endless fibers that falls due to gravity, wherein the at least two counter-rotating rollers are configured to receive between them the curtain of molten endless fibers to produce a 3D tangle of irregularly distributed endless fibers which are looped and fused with one another, wherein the at least two counter-rotating rollers also being configured to feed the produced 3D tangle to the cooling liquid reservoir for solidification, and wherein the device is configured to implement, during extrusion, at least one of: i) at least one of temporally or locally varying the extrusion pressure, or ii)
varying a conveyance speed at which the curtain is conveyed through the at least two counter-rotating rollers.
